(19) United States
(12) Patent Application Publication
(10) Pub. No.: US 2011/0248484 A1
(43) Pub. Date: Oct. 13, 2011

(54) SIDE CURTAIN AIRBAG INSTALLATION SYSTEM

(75) Inventors: Timothy Scott, Benfleet (GB); Raf Haidar, Coventry (GB); Markus Koelsch, Koeln (DE); Marcus John Scott Ward, Billericay (GB)

(73) Assignee: FORD GLOBAL TECHNOLOGIES, LLC, Dearborn, MI (US)

(21) Appl. No.: 13/085,732

(22) Filed: Apr. 13, 2011

(30) Foreign Application Priority Data
Apr. 13, 2010 (DE) 10 2010 003 918.7

(51) Int. Cl. B60R 21/16

(52) U.S. Cl. 280/730.2

(57) ABSTRACT

Installation system for fastening a side curtain airbag to a motor vehicle comprising an airbag with a hollow filling portion which may be inflated by a gas generator and a fastening edge. The installation system has a laterally open fastening profile with a continuous groove which may correspond to the length of the airbag. The fastening profile is arranged on the vehicle and defines a slit-like opening. A thickened guide extends along the fastening edge and is configured to be inserted into the fastening profile. The thickened guide is received in the groove and has a cross section that is at least partially larger than the slit-like opening of the fastening profile.

### CROSS-REFERENCE TO RELATED APPLICATIONS

This application claims foreign priority benefits under 35 U.S.C. §119(a)-(d) to DE 10 2010 003 918.7, filed Apr. 13, 2010, which is hereby incorporated by reference in its entirety.

### TECHNICAL FIELD

The present invention relates to an installation system for an airbag.

### BACKGROUND

Head airbags, also known as side curtain airbags, are integrated in the roof frame and/or installed at that point. Side curtain airbags may start at the A-pillar and may extend over all the seat rows and are integrated in the vehicle roof. They are deployed inside the side window in the event of an accident. Side curtain airbags are deployed in the manner of a curtain and inflated.

Side curtain airbags receive extensive volumes of gas and are deployed in the region of the window. The airbag is voluminous in the non-inflated state and installed state. Because installation space is limited, side curtain airbags are folded in very different ways to achieve a compact design.

The side curtain airbag is installed by a plurality of connecting elements on the roof frame or on other parts of the vehicle. Examples of connecting elements may comprise bolts, screws, rivets, hooks, rods, cables, brackets, push-on clips, nails, cables or rod systems. Connecting elements are fastened, on the one hand, to the vehicle and, on the other hand, to the airbag, at reinforced fastening points.

The airbag is carefully installed to prevent it from being twisted or being hampered by the other parts in the fastening region, such as grab handles, etc.

The airbag is difficult to position due to its construction and size. Thus the installation may be carried out by a plurality of operating steps and/or operators. Installation aids may be used for temporary alignment and securing the airbag. When the side curtain airbag is secured in position, the airbag is fixed to the vehicle using the connecting elements. This procedure may be complicated due to the construction and size of the airbag, depending on the type of fastening elements used. Conventional connecting elements are aligned and installed with difficulty and it is complicated to fasten the airbag correctly to the vehicle.

An installation system and a method for fastening a side impact protection curtain airbag to a vehicle are disclosed in DE 10 2004 003 951 A1. The installation system comprises one or more airbag retainers, which comprise a plate which is positioned in the vehicle. The plate may be a separate structure which may be fastened to a vehicle, or a surface of the vehicle bodywork to which the airbag may be fastened. The plate comprises one or more first tabs and one or more second tabs which are designed so that they define a receiving region in the plate. The first and second tabs are designed so that the second tabs are reversed relative to the first tabs. An airbag with one or more slits and a hemmed portion may also be added to the installation system. The installation system fastens the curtain airbag and engages the first and second tabs to secure a portion of the hemmed portion of the airbag within the receiving region formed in the plate.

This clip system provides an improvement to the installation process because the airbag may be suspended on the tabs of the clips by its hemmed portion or fastening edge. However, viewed along its length, the airbag may still be twisted and a plurality of clip plates must be aligned and fastened with the airbag suspended on the clip plates.

### SUMMARY

On the other hand, it is the object of the invention to provide a side curtain airbag that is installed in a simplified and reliable manner.

### BRIEF DESCRIPTION OF THE DRAWINGS

FIG. 1 shows a schematic, perspective exploded view of one embodiment of an installation system for a side curtain airbag;

FIG. 2 shows a schematic view of a second embodiment of an installation system for a side curtain airbag in cross section; and

FIG. 3 shows a schematic, perspective view of a third embodiment of an installation system for a side curtain airbag.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The airbag may be installed in a simple manner because the installation system has an open fastening profile with a continuous groove which is arranged on the vehicle or on the airbag. In the installed state, a slit-like opening is formed along the fastening profile. A thickened guide extends along the fastening edge and is arranged on the airbag or on the vehicle. The guide is configured to be inserted into the fastening profile. The thickened guide has at least partially a larger cross section than the slit-like opening on the fastening profile and is received in the groove.

The airbag is guided by the thickened guide being received in the groove and is guided through the slit-like opening in a defined manner when installed to prevent twisting of the airbag during installation and positioning in a defined position relative to the vehicle. Installation is considerably simplified and accelerated because the thickened guide may be automatically arranged and secured. Installation of the airbag is preferably carried out manually with a reduced degree of difficulty. Installation may be carried out automatically.

In one embodiment, the thickened guide is formed from a hemmed loop of the fastening edge of the airbag, in which a profile may be additionally inserted. The profile may be a solid or hollow bar.

In an alternative embodiment, the thickened guide is formed from a separate part which is connected to the fastening edge of the airbag, for example, by being stitched or welded. A rail or bar may be used with a shape that corresponds to the fastening profile and is then fastened to the airbag sleeve.

The separate part has a larger cross section region that forms the thickened guide and a region of smaller cross section that extends through the slit-like opening. One region of the profile is received in the groove and the other region is inserted through the slit-like opening and connected to the airbag.

The fastening profile may be part of the motor vehicle and also part of the airbag. Alternatively, the fastening profile may be formed as a separate component. It is particularly preferred if it is formed by a fold in the bodywork or a specific structural profile.

The fastening profile may be a C-shaped, T-shaped, or a U-shaped grooved profile that is fastened on one side to the bodywork with the groove open toward the bodywork. The unfastened side extends downwardly and opens downwardly to form a slit-like opening.

If the fastening profile is connected to the airbag, it may be formed from a separate part which is connected by, for example, stitching to the fastening edge of the airbag. The thickened guide is then arranged on the vehicle and may be formed by a bodywork flange or a specific structural profile fastened to the bodywork. The fastening profile may in all cases have one or more slit-like openings. The slit-like opening may be formed in any direction.

The airbag per se may be provided with a protective casing (for example shrink-wrap film) to avoid inadvertent deployment or damage.

The airbag is inserted with its thickened guide into a fastening profile which is fastened to the bodywork. The fastening profile corresponds to the length of the airbag and has a slit-like lateral opening in the installed state. The thickened guide has a larger cross section than the slit-like opening of the fastening profile and the thickened guide is received in the correspondingly dimensioned groove. The attachment of the fastening profile to the airbag may in this case also represent a possible variant.

Thus the rolled or gathered-up airbag sleeve and/or the inflatable portion is freely positioned on the slit-like opening, and may be held by the guide in the fastening profile. The process is able to be carried out rapidly and practically without any installation errors.

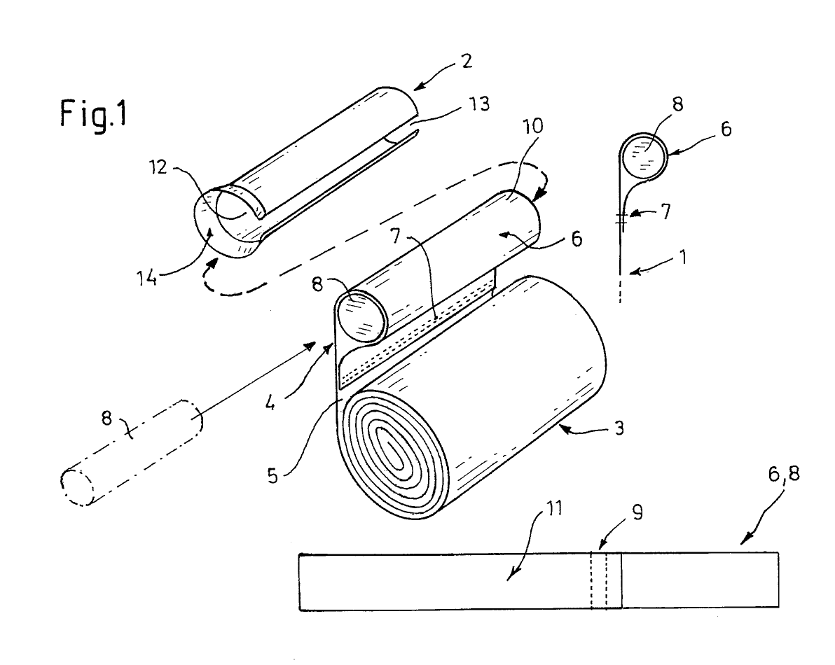

FIG. 1 shows a schematic, perspective exploded view of a side curtain airbag 1 and an installation system for fastening the airbag 1 to the lateral roof strut of a motor vehicle (not shown) by means of a fastening profile 2 made of metal.

The curtain airbag 1 is provided with a hollow filling portion 3, which may be inflated by a gas generator, and a fastening edge 4. In the illustrated embodiment, the filling portion 3 is rolled up for installation. The free end 5 of the filling portion 3 is folded over to form a loop 6 and is attached by a stitched seam 7.

A bar 8 which is round in cross section and made of plastic is inserted into the loop 6. The bar, in combination with the loop 6, forms the thickened guide 10 that extends along the fastening edge 4. The bar 8 is fixed to the loop 6 by means of a seam 9. The bar 8 may be longer than the loop 6, so that a part partially protrudes as a grip 11 to be used for inserting the fastening edge 4 into the fastening profile 2.

The fastening profile 2 is a laterally open profile which is C-shaped in section, with a continuous groove 12 which corresponds to the length of the rolled-up airbag and is fixed to the lateral roof strut of a motor vehicle by welding. Additionally, the profile 2 has a slit-like continuous opening 13.

The fastening profile 2 has a widened portion 14 at one end which serves as an insertion aid.

The thickened guide 10 of the fastening edge 4 is pushed laterally into the fastening profile 2 through the widened portion 14. The thickened guide 10 has a larger cross section than the slit-like opening 13 of the fastening profile 2. The thickened guide 10 is received in the groove 12 and is fixed in the fastening profile 2 and is disposed in the profiled groove 12.

The rolled-up filling portion 3 hangs beyond the free end 5 and the loop 6 on the thickened guide 10 of the fastening edge 4. The loop 6 extends through the slit-like opening 13, so that the rolled-up filling portion 3 hangs freely outside the profile 2.

Several different options may be used to secure or fix the thickened guide 10 and the airbag 1 relative to the profile axially, i.e. in the longitudinal direction of the groove 12. On the one hand, the profile 2 may be provided in the end regions with bendable tabs for closing the groove 12. Alternatively, the widened portion 14 may be bent to secure the thickened guide 10, and the other end of the profile 2 may be correspondingly deformed. On the other hand, bolts, screws, rivets, etc. may also be used for securing the thickened guide 10 axially within the profile 2. The thickened guide 10 may be secured by the fastening of the gas generator.

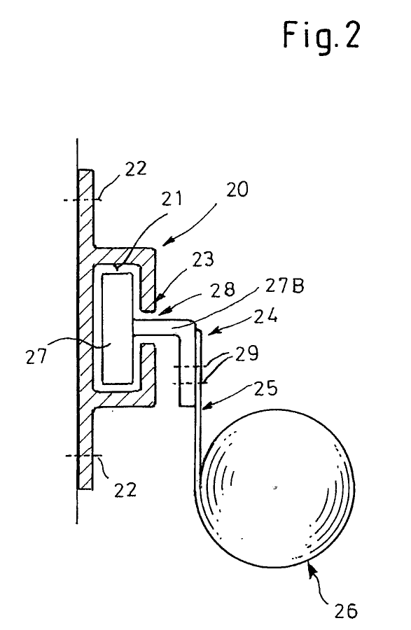

The embodiment of FIG. 2 differs from that of FIG. 1 substantially by the modified profile shape of the fastening profile and the creation of the thickened guide of the fastening edge.

Referring to FIG. 2, it is acknowledged that a fastening profile 20 has a T-shape and a groove 21 has a rectangular cross section. The fastening profile 20 is produced as an extruded plastic profile which is attached via rivets 22 to the bodywork.

A thickened guide 23 of a fastening edge 24 of a free end 25 of a side curtain airbag 26 has a rectangular cross section and is formed by a corresponding plastic bar 27. The bar 27 is stitched via a seam 29 to the free end 25. The bar 27 has a bent-back part 27B that extends through a slit-like opening 28.

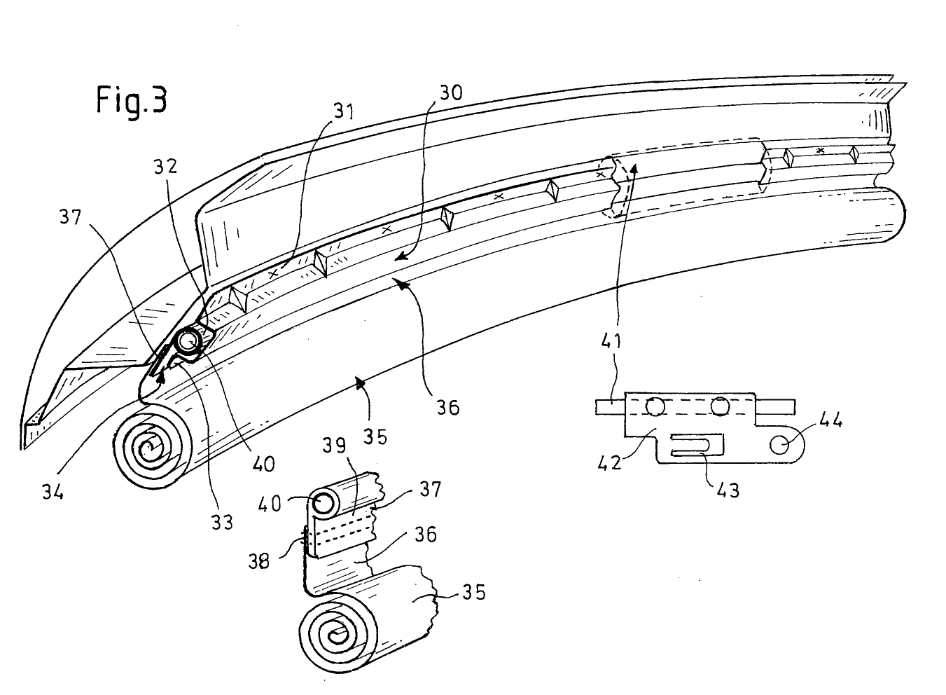

The embodiment of FIG. 3 differs from that of FIGS. 1 and 2, substantially by the modification of the fastening profile and the creation of the thickened guide of the fastening edge. It is substantially a type of combination of the two previous embodiments.

In the example of FIG. 3, a fastening profile 30 is an approximately U-shaped profile metal sheet which is fastened to the bodywork on an upper side 31 by welded points. A groove 32 is open toward the bodywork, and an unfastened side 33 is oriented downward, and thus forms a slit-like opening 34 which is open downward.

A rolled-up filling portion 35 hangs beyond a free end 36 on a thickened guide 37 of a fastening edge 38. The guide is formed by a separate material loop 39, in which a corresponding plastic bar 40 is inserted which is then stitched up and stitched onto the free end 36. The same material may be used for the material loop 39 as the material in the airbag sleeve. During and after installation, the loop 39 engages through the slit-like opening 34, so that the rolled-up filling portion 35 hangs freely outside the profile 30 and the airbag is guided during installation to avoid twisting.

A gas generator 41 is fixed by an angle bracket 42 to the bodywork behind the fastening profile 30 as a particularity of the embodiment of FIG. 3. The angle bracket 42, in turn, is fastened with a lug 43 and a screw connection 44 to the bodywork. The screw connection is made after installing the fastening profile 30 and inserting the guide 37. The screw connection extends through the guide so that all three parts are affixed at the same time.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An installation system for an airbag, in particular a side curtain airbag, to a motor vehicle comprising:
an airbag with a hollow filling portion which may be inflated by a gas generator and a fastening edge;
a fastening profile with a continuous groove which is arranged on the vehicle and defines a slit-like opening along the fastening profile;
a thickened guide extends along the fastening edge of the airbag and is configured to be inserted into the fastening profile, the thickened guide has a cross section that is at least partially longer than the slit-like opening on the fastening profile, and wherein the thickened guide is received in the groove.

2. The installation system as claimed in claim 1, wherein the thickened guide is formed from a hemmed loop of the fastening edge of the airbag.

3. The installation system as claimed in claim 2, further comprising a bar is inserted into the hemmed loop of the fastening edge.

4. The installation system as claimed in claim 1, wherein the thickened guide is formed from a separate part which is connected to the fastening edge of the airbag.

5. The installation system as claimed in claim 4, wherein the separate part has a region of larger cross section for forming the thickened guide and a region of smaller cross section that extends through the slit-like opening.

6. The installation system as claimed in claim 1, wherein the fastening profile is separately formed and fastened to the motor vehicle.

7. The installation system as claimed in claim 1, wherein the fastening profile is formed as a separate part which is stitched to the fastening edge of the airbag.

8. The installation system as claimed in claim 8, wherein the thickened guide is a specific structural profile fastened to the motor vehicle.
